(19) United States
(12) Patent Application Publication
(10) Pub. No.: US 2025/0192885 A1
(43) Pub. Date: Jun. 12, 2025

(54) DETECTING PULSED OPTICAL BEAMS

(71) Applicant: Fraunhofer UK Research Ltd, Glasgow (GB)

(72) Inventors: Matthew S. Warden, Glasgow (GB); Haochang Chen, Glasgow (GB)

(73) Assignee: Fraunhofer UK Research Ltd, Glasgow, JQ (GB)

(21) Appl. No.: 18/844,897

(22) PCT Filed: Mar. 14, 2023
(86) PCT No.: PCT/GB2023/050598

§ 371 Date: Sep. 6, 2024

(30) Foreign Application Priority Data
Mar. 14, 2022 (GB) 2203497.9

(51) Int. Cl. H04B 10/11; H04B 10/60

(52) U.S. Cl. CPC H04B 10/11; H04B 10/60

(57) ABSTRACT

A method is disclosed for use in detecting a pulsed optical beam when the pulsed optical beam is transmitted through a scattering medium, wherein the pulsed optical beam comprises a plurality of optical pulses and the method comprises using a plurality of photodetectors of a photodetector array to detect light which is scattered progressively from the same optical pulse as the optical pulse propagates through a plurality of regions of the scattering medium and which is then received progressively on different photodetectors of the photodetector array. The method may be used in particular, though not exclusively, for non-line-of-sight free-space optical communications. An optical receiver for use in detecting the pulsed optical beam and an associated optical system are also disclosed.

### FIELD

The present disclosure relates to a method for use in detecting a pulsed optical beam, an optical receiver for use in detecting a pulsed optical beam, and an associated optical system, for use in particular, though not exclusively, in non-line-of-sight free-space optical communications.

### BACKGROUND

Free-space optical communication (FSOC) systems are known for communication across the sky. Such FSOC systems are generally free of electromagnetic spectrum restrictions. Such FSOC systems may be difficult for an adversary to detect, intercept and/or disrupt. For example, FSOC systems are known for communication across the sky along a direct line-of-sight (LOS) between an optical transmitter and an optical receiver. However, it may not be possible to use such direct line-of-sight (LOS) FSOC systems when an obstacle obstructs the LOS between the optical transmitter and the optical receiver. Accordingly, it is known to use non-line-of-sight (NLOS) free-space optical communications between an optical transmitter and an optical receiver. Such known NLOS methods rely upon the scattering of light transmitted from the optical transmitter from air molecules and/or particulates such as pollutants suspended in the atmosphere and detection of the scattered light by the optical receiver. For example NLOS FSOC systems are known which use UV-C light for NLOS free-space optical communications outdoors because sunlight is strongly absorbed by the earth's atmosphere at UV-C wavelengths, and therefore there is very little background light from the sun at the earth's surface at UV-C wavelengths, even during daytime. In effect, this means that a weak UV-C signal which is scattered from the atmosphere may be detected even during the daytime due to the lack of background radiation at UV-C wavelengths. However, such known NLOS FSOC systems may have a limited range which is insufficient for communicating over longer distances.

### SUMMARY

According to an aspect of the present disclosure there is provided a method for use in detecting a pulsed optical beam comprising a plurality of optical pulses when the pulsed optical beam is transmitted through a scattering medium, the method comprising:
using a plurality of photodetectors of a photodetector array to detect light which is scattered progressively from the same optical pulse as the optical pulse propagates through a plurality of regions of the scattering medium and which is then received progressively on different photodetectors of the photodetector array.

Such a method may have a greater contrast or an improved signal-to-noise ratio (SNR) compared with known methods for detecting pulsed optical beams not least because each photodetector of the photodetector array may detect light which is scattered from the same optical pulse as the optical pulse propagates through the different regions of the scattering medium, thereby enabling a plurality of measurements of the light scattered from the same optical pulse to be performed. This may facilitate NLOS FSOC over a greater range than prior art NLOS FSOC methods, even in daylight.

Optionally, the method comprises using the plurality of photodetectors of the photodetector array to detect light which is scattered progressively from each optical pulse as each optical pulse propagates through the plurality of regions of the scattering medium and which is then received progressively on different photodetectors of the photodetector array.

Optionally, the method comprises imaging each region of the scattering medium onto a corresponding photodetector of the photodetector array.

Optionally, the method comprises imaging light scattered from each optical pulse onto the photodetector array so as to form an image of the light scattered from each optical pulse on the photodetector array, wherein the image of each optical pulse moves progressively along the different photodetectors of the photodetector array as a result of the propagation of each optical pulse through the plurality of regions of the scattering medium.

Optionally, a length of the image of the light scattered from each optical pulse on the photodetector array is greater than, or comparable to, or equal to, a length of each photodetector.

Optionally, a width of the image of the light scattered from the pulsed optical beam on the photodetector array is greater than, or comparable to, or equal to, a width of each photodetector.

Optionally, the method comprises:
detecting the scattered light received on each photodetector from the corresponding region of the scattering medium as a function of time so as to generate a corresponding time-varying photodetector signal; and
using the plurality of photodetector signals to determine a time-varying optical receiver signal representative of a time-varying intensity of the pulsed optical beam.

Optionally, using the plurality of photodetector signals to determine the optical receiver signal comprises applying one or more time-shifts to the plurality of photodetector signals to compensate the plurality of photodetector signals for differences between the arrival times of light scattered from the different regions of the scattering medium onto the different photodetectors of the photodetector array.

Optionally, applying the one or more time-shifts to the plurality of photodetector signals to compensate the plurality of photodetector signals for differences between the arrival times of light from the different regions of the scattering medium onto the different photodetectors of the photodetector array comprises selecting one of the photodetector signals as a reference photodetector signal and applying a different time-shift to each of the one or more other photodetector signals so as to generate one or more time-shifted photodetector signals.

Optionally, using the plurality of photodetector signals to determine the optical receiver signal comprises adding the reference photodetector signal and the one or more time-shifted photodetector signals together so as to generate a time-varying summed photodetector signal.

Optionally, the summed photodetector signal is the optical receiver signal representative of the time-varying intensity of the pulsed optical beam.

Optionally, the method comprises cross-correlating a time window function with the summed photodetector signal to generate the optical receiver signal representative of the time-varying intensity of the pulsed optical beam.

Optionally, the time window function has a duration which is comparable to, or equal to, a duration of an arrival period of light which is scattered from each optical pulse and received on the photodetector array.

Optionally, using the plurality of photodetector signals to determine the optical receiver signal comprises cross-correlating different time-shifted time window functions with the different photodetector signals to generate a plurality of time-shifted cross-correlated photodetector signals.

Optionally, using the plurality of photodetector signals to determine the optical receiver signal comprises applying one or more time-shifts to a time window function to compensate the time window function for differences between the arrival times of light from the different regions of the scattering medium onto the different photodetectors of the photodiode array.

Optionally, using the plurality of photodetector signals to determine the optical receiver signal comprises adding the plurality of time-shifted cross-correlated photodetector signals so as to generate a time-varying summed photodetector signal photodetector signal.

Optionally, the summed cross-correlated photodetector signal is the optical receiver signal representative of the time-varying intensity of the pulsed optical beam.

Optionally, wherein each time-shifted time window function has a duration which is comparable to, or equal to, a duration of an arrival period of light which is scattered from each optical pulse and received on the photodetector array.

Optionally, the method comprises spectrally filtering light received from the scattering medium before the light is incident on the plurality of photodetectors of the photodetector array so as to remove background light at a wavelength which falls outside a spectral bandwidth of the pulsed optical beam.

Optionally, the method comprises determining the different time-shifts associated with the different photodetectors according to a speed at which the light scattered from the different regions of the scattering medium moves across the different photodetectors of the photodetector array.

Optionally, determining the different time-shifts associated with the different photodetectors comprises transmitting a pulsed optical calibration beam through the scattering medium, the pulsed optical calibration beam comprising a known calibration sequence of optical pulses.

Optionally, determining the different time-shifts associated with the different photodetectors comprises, for each photodetector of the photodetector array:
detecting light which is scattered from the pulsed optical calibration beam as the pulsed optical calibration beam propagates through the corresponding plurality of different regions of the scattering medium and received on the photodetector to generate a corresponding time-varying photodetector calibration signal;
cross-correlating the photodetector calibration signal with the known calibration sequence of optical pulses of the pulsed optical calibration beam to generate a cross-correlated calibration signal; and
determining the time-shift for the photodetector from a timing of a peak value of the cross-correlated calibration signal.

Optionally, the method comprises referencing clocks of the transmitter and receiver to a GNSS satellite signal such as a GPS disciplined reference oscillator. This may improve the relative stability of the clocks of the transmitter and receiver and improve a signal-to-noise ratio (SNR) of the method.

Optionally, the method comprises aligning the photodetector array relative to the pulsed optical beam so that the plurality of photodetectors of the photodetector array are capable of receiving light which is scattered from the pulsed optical beam as the pulsed optical beam propagates through the corresponding plurality of regions of the scattering medium.

Optionally, aligning the photodetector array relative to the pulsed optical beam comprises:
(i) transmitting a pulsed optical alignment beam through the scattering medium, the pulsed optical alignment beam comprising a known alignment sequence of optical pulses;
(ii) aligning the photodetector array so as to receive, on the plurality of photodetectors of the photodetector array, light from a corresponding plurality of different regions of the scattering medium arranged along a trial optical path while the pulsed optical alignment beam is propagating through the scattering medium;
(iii) for each photodetector of the photodetector array:
   detecting the light received on the photodetector from the corresponding region of the scattering medium as a function of time to generate a corresponding time-varying photodetector alignment signal;
   cross-correlating the photodetector alignment signal with the known alignment sequence of optical pulses of the pulsed optical alignment beam to generate a cross-correlated alignment signal; and
   determining a peak value of the cross-correlated alignment signal;
(iv) repeating steps (ii) and (iii) for a plurality of different trial optical paths; and
(v) aligning the photodetector array so as to receive, on the plurality of photodetectors of the photodetector array, light from the corresponding plurality of different regions of the scattering medium which are arranged along the trial optical path which optimises or maximises the peak value of one or more of the cross-correlated alignment signals.

Aligning the photodetector array relative to the pulsed optical beam may allow the pulsed optical beam to be detected. This may have applications for the detection of pulsed optical beams such as a pulsed laser beam of a laser range finder, a pulsed laser beam of a laser target designator, or a pulsed laser beam of a FSOC system such as a LOS FSOC system or a NLOS FSOC system.

Optionally, the pulsed optical alignment beam is the same as the pulsed optical calibration beam and/or the known alignment sequence of optical pulses is the same as the known calibration sequence of optical pulses.

According to an aspect of the present disclosure there is provided an optical communication method, for example a NLOS FSOC method, wherein the optical communication method comprises:
transmitting a pulsed optical beam through the scattering medium, the pulsed optical beam comprising a plurality of optical pulses; and
the method for use in detecting a pulsed optical beam as described above.

Optionally, the plurality of optical pulses of the pulsed optical beam are configured so as to carry or encode data or information.

Optionally, the optical communication method comprises extracting or decoding the data or information carried by, or encoded in, the plurality of optical pulses from the determined time-varying optical receiver signal.

Optionally, the plurality of optical pulses of the pulsed optical beam are configured to carry or encode the data or information according to a modulation or encoding scheme with a maximum peak to average power ratio. The signal-to-noise ratio (SNR) at the photodetector array may be determined by the ratio of the peak received optical power of the communications signal relative to the received optical power of the background light. Thus, maximising the peak to average power ratio may maximise the SNR at the photodetector array.

The average optical power of the transmitted optical beam may be fixed, e.g. at a level dictated by laser safety requirements, the available power at the optical transmitter, technical limitations of the optical transmitter, or a desire for the transmitted optical beam to be hard to detect by third parties. For a given average optical power, the peak power may depend on a pulse duration and a pulse repetition rate. The SNR may therefore be determined at least in part by the peak to average power ratio of the chosen modulation scheme, with a larger peak to average power ratio leading to a larger SNR. Therefore, it may be advantageous to choose a modulation or encoding scheme with a high peak to average power ratio. Use of a modulation or encoding scheme with a higher peak to average power ratio may therefore enable optical communications such as NLOS FSOC over longer distances.

Optionally, the plurality of optical pulses of the pulsed optical beam are configured to carry or encode the data or information according to a modulation or encoding scheme having a peak to average power ratio of 100 or more, 1,000 or more or 10,000 or more. Optionally, the data or information is carried or encoded using a pulse analogue modulation method.

Optionally, the data or information is carried or encoded using Pulse Position Modulation (PPM). A PPM modulation scheme is characterised by the number of time slots into which an optical pulse may be transmitted. Typically, the larger the number of time slots, the larger the peak to average power ratio. Optionally, the PPM modulation scheme has a large number of time slots e.g. 16 or more timeslots, 32 or more timeslots, 64 or more timeslots, 128 or more timeslots, 256 or more timeslots, 512 or more timeslots, or 1024 or more timeslots.

Optionally, the data or information is carried or encoded using Pulse Amplitude Modulation (PAM) or Pulse Width Modulation (PWM).

Optionally, the data or information is carried or encoded using a pulse code modulation (PCM) method such as on/off keying, return-to-zero signalling or the like.

The method may comprise modulating a direction of the pulsed optical beam. A potential advantage of doing this includes transmitting more information. This may also make it harder for an adversary to detect or intercept a communication. For example, the method may comprise modulating a pitch of the pulsed optical beam by angling the pulsed optical beam upwardly or downwardly. This may, for example, be advantageous where the pulsed optical beam passes directly over the top of the optical receiver. Angling the pulsed optical beam slightly up or down will have little effect upon the time-varying optical receiver signal representative of the time-varying intensity of the pulsed optical beam detected at the optical receiver because the image of the pulsed optical beam will stay in the same place on an image plane of the optical receiver, and there will be a very small variation in the timing of the received scattered light which could either be ignored if it is small enough, or compensated for in the analysis of the time-varying optical receiver signal. However, an adversary that is attempting to detect or intercept the communication will see a moving pulsed optical beam (unless they are on a direct line between the optical transmitter and the optical receiver), and this will make it harder to detect or intercept the signal because the adversary's optical receiver would have to compensate for the motion of the pulsed optical beam, whereas the legitimate optical receiver of the communication does not have to compensate for the motion of the pulsed optical beam.

The method may comprise modulating a yaw of the pulsed optical beam. Again, consider a situation where the pulsed optical beam passes directly over the top of the optical receiver. If the yaw of the pulsed optical beam is modulated, the optical receiver will see the pulsed optical beam moving on the image plane. If the optical receiver has a 2D photodetector array then both the timing of the optical pulses and the direction of the optical pulses can be recorded.

The method may comprise using the direction of the pulsed optical beam to encode additional information.

The method may comprise transmitting one or more additional optical beams which are additional to the pulsed optical beam used for communication.

For example, the method may comprise transmitting additional optical beams to the left and/or right of the pulsed optical beam used for communication, wherein the pulsed optical beam used for communication passes directly over the top of the optical receiver. The legitimate optical receiver can ignore these additional optical beams, as their images fall upon different locations on the image plane in which the photodetector array is located. However, an adversary that is far enough away from a direct line between the optical transmitter and the optical receiver will receive scattered light from both the pulsed optical communication beam and these additional optical beams upon the same part of the image plane of the adversary's optical receiver. This reduces the signal to background light ratio for the adversary's optical receiver (where the additional optical beams are considered to produce background light in this case). The method may comprise deliberately modulating a direction of, and/or encoding data on, the one or more additional optical beams to produce a signal that is confusing for an adversary trying to intercept the signal, for example with a similar type of modulation but different transmitted data—so that the adversary's optical receiver cannot tell which light came from the pulsed optical communication beam and which light came from the additional optical beams.

The method may comprise modulating a direction of the pulsed optical beam using a plurality of pulsed optical sources, wherein each pulsed optical source is configured to transmit a corresponding pulsed optical beam in a different direction at a different time. For example, an array of optical sources may be placed one focal length away from a collimating lens. Additionally or alternatively, the direction of the pulsed optical beam may be modulated using a fast-moving mirror. Additionally or alternatively, the direction of the pulsed optical beam may be modulated using a fast optical switch to direct light to different outputs, each of which transmits the pulsed beam in a corresponding different direction.

Additionally or alternatively, the method may comprise modulating a divergence of the pulsed optical beam for example using an elliptical lens.

The method may comprise using Wavelength Division Multiplexing (WDM) to increase the transmitted data rate. Specifically, the pulsed optical beam may comprise a plurality of different carrier wavelengths with a different stream of data encoded on each carrier wavelength and the method may comprise separating the different carrier wavelengths onto different photodetectors. The optical receiver may, for example, include a dispersive element such as a prism or diffraction grating for this purpose.

According to an aspect of the present disclosure there is provided a method for determining one or more properties of a scattering medium, wherein the pulsed optical beam comprises a plurality of optical pulses having a known probe sequence, and wherein the method comprises:
transmitting a pulsed optical beam through the scattering medium, the pulsed optical beam comprising a plurality of optical pulses having a known probe sequence;
the method for use in detecting a pulsed optical beam as described above;
detecting the scattered light received on each photodetector from the corresponding region of the scattering medium as a function of time so as to generate a corresponding time-varying photodetector signal;
using the plurality of photodetector signals to determine a time-varying optical receiver signal representative of a time-varying intensity of the pulsed optical beam; and
using the known probe sequence and the determined time-varying optical receiver signal to determine one or more properties of the scattering medium.

According to an aspect of the present disclosure there is provided an optical receiver for use in detecting a pulsed optical beam which comprises a plurality of optical pulses when the pulsed optical beam is transmitted through a scattering medium, the optical receiver comprising:
a photodetector array which includes a plurality of photodetectors,
wherein the optical receiver is configured so that the plurality of photodetectors of the photodetector array detect light which is scattered progressively from the same optical pulse as the optical pulse propagates through a plurality of regions of the scattering medium and which is then received progressively on different photodetectors of the photodetector array.

Optionally, the optical receiver is arranged so that the plurality of photodetectors of the photodetector array detect light which is scattered progressively from each optical pulse as each optical pulse propagates through a plurality of different regions of the scattering medium and which is then received progressively on the plurality of different photodetectors of the photodetector array.

Optionally, the photodetector array comprises an array of single-photon detectors.

Optionally, the photodetector array comprises an array of single-photon avalanche diodes (SPADs).

Optionally, the photodetector array comprises an array of Silicon Photomultipliers (SiPM), an array of Multi Pixel Photon Counters (MPPC) or an array of photomultiplier tubes (PMT).

Optionally, the photodetector array comprises an array of photodiodes such as an array of fast photodiodes.

Optionally, the photodetector array comprises an array of photomultiplier tubes.

Optionally, the photodetector array comprises a linear array of photodetectors.

Optionally, the photodetector array comprises a 2D array of photodetectors. Use of a 2D array of photodetectors may help to align the photodetector array relative to the pulsed optical beam, for example by relaxing the alignment tolerances between the photodetector array and the pulsed optical beam. In the case, the 2D photodetector array does not need to be aligned to the laser beam with precision but instead it just needs to be determined which photodetectors are collecting light from the pulsed optical beam, and which are not, so that the photodetector signals from the correct photodetectors can be combined to generate the time-varying optical receiver signal which is representative of the time-varying intensity of the pulsed optical beam.

Optionally, the optical receiver comprises an imaging system for imaging each region of the scattering medium onto a corresponding photodetector of the photodetector array.

Optionally, the optical receiver comprises an imaging system for imaging light scattered from each optical pulse onto the photodetector array so as to form an image of each optical pulse on the photodetector array, wherein the image of each optical pulse moves progressively along the different photodetectors of the photodetector array as a result of the propagation of each optical pulse through the plurality of different regions of the scattering medium.

Optionally, the optical receiver comprises a plurality of optical waveguides such as a plurality of optical fibres.

Optionally, one end of each optical waveguide is positioned in an image plane of the imaging system and each optical waveguide is arranged so as to guide light received from the imaging system onto a corresponding one of the photodetectors of the photodetector array.

Optionally, the optical receiver comprises a spectral filter for spectrally filtering light received from the scattering medium before the light is incident on the plurality of photodetectors of the photodetector array so as to remove background light at a wavelength which falls outside a spectral bandwidth of the pulsed optical beam.

Optionally, each optical pulse has a duration of between 1 ns and 100 ns.

Optionally, the pulsed optical beam comprises UV-B light, UV-A light, visible light, or infra-red (IR) light, for example near-IR light, short-wavelength IR light or mid-IR light.

Use of a pulsed optical beam comprising UV-B light, UV-A light, visible light, or infra-red (IR) light, for example near-IR light, short-wavelength IR light or mid-IR light may allow communications over greater distances than the use of a pulsed optical beam of UV-C light.

Use of a pulsed optical beam comprising UV-B light, UV-A light, visible light, or infra-red (IR) light, for example near-IR light, short-wavelength IR light or mid-IR light may result in an increased fraction of scattered light being Mie scattering which is more directional than the scattering which occurs when using UV-C light, thereby making it harder for an adversary to detect the pulsed optical beam.

Optionally, the pulsed optical beam comprises pulsed coherent light.

Optionally, the pulsed optical beam comprises a pulsed laser beam.

According to an aspect of the present disclosure there is provided an optical system comprising:
the optical receiver as described above; and
an optical transmitter for transmitting the pulsed optical beam through the scattering medium to thereby cause light from each optical pulse to be scattered by the scattering medium when each optical pulse propagates through the plurality of different regions of the scattering medium.

Optionally, the optical transmitter comprises a pulsed optical source which is configured to generate the plurality of optical pulses.

Optionally, the optical transmitter is configured to generate optical pulses having a duration of between 1 ns and 100 ns.

Optionally, the optical transmitter is configured to generate a plurality of optical pulses of UV-B light, UV-A light, visible light, or infra-red (IR) light, for example near-IR light, short-wavelength IR light or mid-IR light.

Optionally, the optical transmitter comprises a pulsed source of coherent light.

Optionally, the optical transmitter comprises a pulsed laser.

Optionally, the optical transmitter comprises a Q-switched laser. In a Q-switched laser, energy fed into the laser gain medium accumulates there and is stored until it is released when the laser emits a pulse. This facilitates the emission of a plurality of optical pulses with a high peak to average power ratio as it reduces the peak power requirement on the system providing power to the laser.

It should be understood that any one or more of the features of any one of the foregoing aspects of the present disclosure may be combined with any one or more of the features of any of the other foregoing aspects of the present disclosure.

### BRIEF DESCRIPTION OF THE DRAWINGS

A method of detecting a laser beam will now be described by way of non-limiting example only with reference to the drawings of which:

FIG. 1 is a schematic of a non-line-of-sight optical system;

FIG. 2 is a more detailed schematic of the non-line-of-sight optical system of FIG. 1;

FIG. 3A shows a sequence of optical pulses of a pulsed optical beam;

FIG. 3B shows the time-varying single-photon avalanche diode (SPAD) signals generated by four different SPADs of an optical receiver of the system of FIG. 1 on detection of light scattered from the sequence of optical pulses of FIG. 3A;

FIG. 3C shows the time-varying single-photon avalanche diode (SPAD) signals of FIG. 3B after time-shifting three of the four different SPAD signals;

FIG. 3D shows a summed SPAD signal generated by adding the SPAD signals of FIG. 3C;

FIG. 3E shows a time window function;

FIG. 3F shows a time-varying optical receiver signal resulting from cross-correlation of the time window function of FIG. 3E with the summed SPAD signal of FIG. 3D;

FIG. 4A shows a known calibration sequence of optical pulses;

FIG. 4B shows the time-varying SPAD signals generated by first and second SPADs of the optical receiver of the system of FIG. 1 on detection of light scattered from the known calibration sequence of optical pulses of FIG. 4A with the known calibration sequence of optical pulses superimposed on the time-varying SPAD signal generated by the first SPAD;

FIG. 4C shows a cross-correlation of the time-varying SPAD signal generated by the first SPAD and the known calibration sequence of optical pulses of FIG. 4A;

FIG. 4D shows the time-varying SPAD signals generated by first and second SPADs of the optical receiver of the system of FIG. 1 on detection of light scattered from the known calibration sequence of optical pulses of FIG. 4A with the known calibration sequence of optical pulses superimposed on the time-varying SPAD signal generated by the second SPAD;

FIG. 4E shows a cross-correlation of the time-varying SPAD signal generated by the second SPAD and the known calibration sequence of optical pulses of FIG. 4A;

FIG. 5A shows a sequence of optical pulses of a pulsed optical beam;

FIG. 5B shows the time-varying SPAD signals generated by four different SPADs of an optical receiver of the system of FIG. 1 on detection of light scattered from the sequence of optical pulses of FIG. 5A with a corresponding time-shifted time window function superimposed on each time-varying SPAD signal;

FIG. 5C shows a time-varying optical receiver signal obtained after cross-correlating each SPAD signal of FIG. 5B with the corresponding time-shifted time window function of FIG. 5B and adding the resulting cross-correlated signals;

FIG. 5D shows the movement of an image of an optical pulse and the incidence of background photons on four different SPADs of the optical receiver of the system of FIG. 1 as a function of time;

FIG. 6A is a schematic of the non-line-of-sight optical system of FIG. 1 for the case where an optical transmitter of the optical system emits a pulsed optical beam comprising a shorter optical pulse and each individual single-photon avalanche diode (SPAD) of an optical receiver of the optical system has a wider field-of-view (FOV);

FIG. 6B is a schematic of the non-line-of-sight optical system of FIG. 1 for the case where an optical transmitter of the optical system emits a pulsed optical beam comprising a longer optical pulse and each individual SPAD of an optical receiver of the optical system has a narrower FOV; and

FIG. 6C is a schematic of the non-line-of-sight optical system of FIG. 1 for the case where an optical transmitter of the optical system emits a pulsed optical beam comprising a longer optical pulse and each individual SPAD of an optical receiver of the optical system has a wider FOV.

### DETAILED DESCRIPTION OF THE DRAWINGS

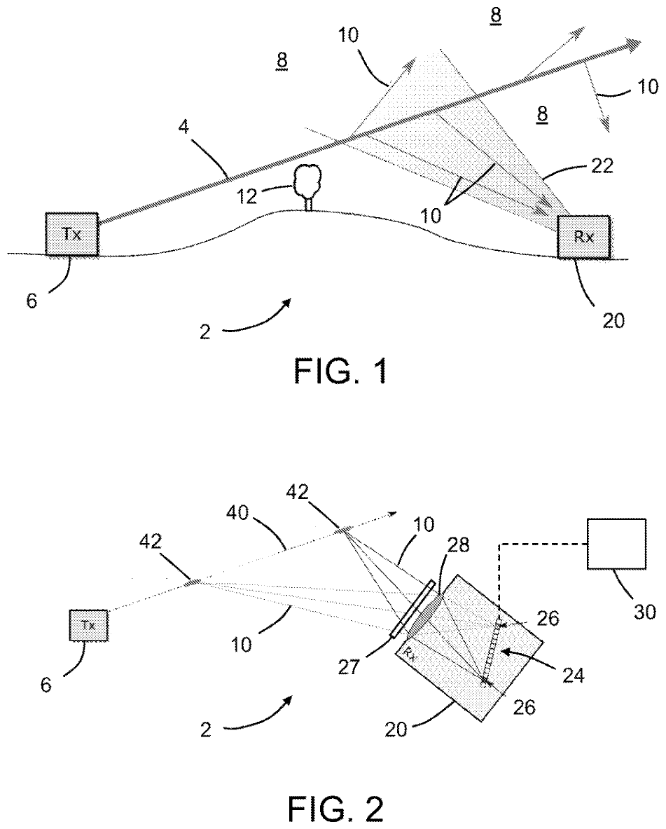

Referring initially to FIG. 1 there is shown a non-line-of-sight optical system generally designated 2 comprising an optical transmitter 6 and an optical receiver 20. The optical transmitter 6 is configured to transmit the pulsed optical beam 4 comprising a plurality of optical pulses through a scattering medium 8 to thereby cause light from each optical pulse to be scattered by the scattering medium 8 to form scattered light 10 when each optical pulse propagates through a plurality of different regions of the scattering medium 8. The pulsed optical beam 4 may comprise a pulsed optical beam of UV-B light, UV-A light, visible light or infrared (IR) light such as a pulsed optical beam of coherent UV-B light, UV-A light, visible light or IR light. For example, the pulsed optical beam 4 may comprise a pulsed laser beam of UV-B light, UV-A light, visible light or IR light. In this regard, the optical transmitter 6 may include a pulsed laser such as a Q-switched laser for generating optical pulses having a duration in the range of 1 ns-100 ns. As will be understood by one of ordinary skill in the art, the scattering medium 8 may take the form of air molecules and/or particulates such as pollutants suspended in the atmosphere. As may be appreciated from FIG. 1, the optical transmitter 6 is configured to transmit the pulsed optical beam 4 over one or more obstacles 12 and the optical receiver 20 is configured to receive the light scattered from each region of the scattering medium 8 located within a field-of-view (FOV) 22 of the optical receiver 20. As will be described in more detail below, the system 2 is a non-line-of-sight (NLOS) system which may be used for detecting the pulsed optical beam 4 for a number of different technical applications and in particular, though not exclusively, for free-space optical communications (FSOC) between the optical transmitter 6 and the optical receiver 20.

Use of a pulsed optical beam 4 of UV-B light, UV-A light, visible light or IR light may result in less absorption and/or scattering in the scattering medium 8 compared with the use of a pulsed optical beam of UV-C light, thereby allowing communications over greater distances compared with the use of a pulsed optical beam of UV-C light. However, as will be described in more detail below, the presence of more background light from the sun during the daytime at UV-B, UV-A, visible or near-IR wavelengths means that the optical receiver 20 needs to be specifically configured to reduce the amount of background light from the sun which is detected to thereby maximise the contrast or signal-to-noise ratio (SNR) of the method of detection.

As shown in FIG. 2, the optical receiver 20 comprises a linear array of photodetectors in the form of a linear array 24 of single-photon avalanche diodes (SPADs) 26. The optical receiver 20 further comprises an imaging system in the form of a lens 28 for imaging light onto the SPAD array 24. The optical receiver 20 further comprises an optical filter 27 disposed in front of the lens 28 so that the lens 28 is positioned between the optical filter 27 and the SPAD array 24. The optical filter 27 defines a narrow spectral passband which is configured to transmit the near-IR light scattered from the pulsed optical beam 4 but to reject any unwanted background light which is incident on the optical filter 27 at a wavelength which falls outside a spectral bandwidth of the pulsed optical beam 4.

The system 2 further comprises a processing resource 30. As indicated by the dashed line in FIG. 2, the processing resource 30 and the SPAD array 24 are configured for communication.

In use, the optical transmitter 6 transmits the pulsed near-IR optical beam 4 along an optical path 40. The optical receiver 20 is aligned with the pulsed optical beam 4 so that light scattered from each optical pulse 42 is filtered by the optical filter 27 and then imaged by the lens 28 onto the SPAD array 24 so as to form an image of the light scattered from each optical pulse 42 on the SPAD array 24, wherein the image of the light scattered from each optical pulse 42 moves progressively along the different SPADs 26 of the SPAD array 24 as each optical pulse 42 propagates through the plurality of different regions of the scattering medium 8 located within the FOV 22 of the optical receiver 20.

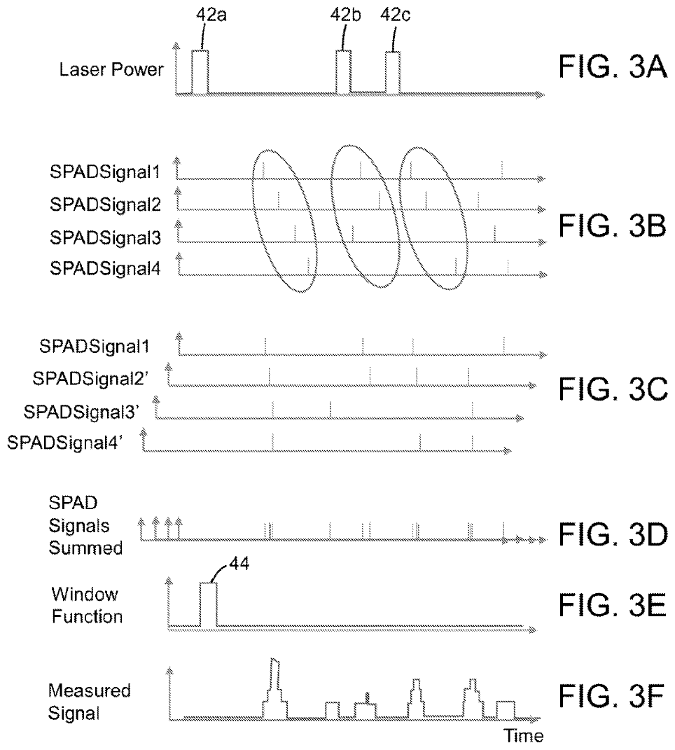

As will now be described with reference to FIGS. 3A to 3F, each SPAD 26 detects the scattered light 10 that it receives from the corresponding region of the scattering medium 8 as a function of time so as to generate a corresponding time-varying photodetector signal in the form of a time-varying SPAD signal and the processing resource 30 uses the plurality of SPAD signals to determine a time-varying optical receiver signal representative of a time-varying intensity of the pulsed optical beam 4.

FIG. 3A shows an example of the variation of the optical power of the pulsed optical beam 4 as a function of time in the form of a sequence of three different optical pulses 42a, 42b and 42c. FIG. 3B shows the corresponding time-varying SPAD signals SPADSignal1-SPADSignal4 detected by four of the SPADs 26 when the optical receiver 20 is aligned with the pulsed optical beam 4 so that the lens 28 images light scattered from the different optical pulses 42a, 42b and 42c onto the SPAD array 24. As will be understood by one of skill in the art, each SPAD 26 generates an electrical pulse such as a voltage pulse when it detects a photon so that each of the time-varying SPAD signals SPADSignal1-SPADSignal4 comprises a series of electrical pulses. The generation of the electrical pulses by each SPAD 26 is statistical in nature with each SPAD 26 generating a series of electrical pulses, wherein the probability of the generation of an electrical pulse at any instant in time generally depends on the instantaneous intensity of the light imaged onto each SPAD 26 by the lens 28, including any light scattered from the pulsed optical beam 4 and any background light.

There is a time delay between the optical transmitter transmitting an optical pulse 42 and each SPAD 26 receiving light scattered from that optical pulse 42. The time delay is in general different for each SPAD 26 because each SPAD 26 receives light scattered from a different region along the optical path 40 of the pulsed optical beam 4 through the scattering medium 8 and it takes a different time for the optical pulses 42 to reach each region, and a different time for scattered light to travel between each region and the corresponding SPAD 26.

One or more of the time-varying SPAD signals SPADSignal1-SPADSignal4 include one or more electrical pulses generated as a result of scattering of the pulsed optical beam 4 from one or more corresponding regions of the scattering medium 8 as one or more of the optical pulses 42 of the pulsed optical beam 4 propagate through the one or more corresponding regions of the scattering medium 8. For example, as highlighted by the leftmost oval in FIG. 3B, each SPAD 26 detects one photon of light scattered from the first laser pulse 42a resulting in a corresponding electrical pulse in each SPAD signal SPADSignal1-SPADSignal4. As highlighted by the middle oval in FIG. 3B, electrical pulses are generated as a result of the arrival of background photons on the different SPADs 26. These background photons arrive at random times. As highlighted by the rightmost oval in FIG. 3B, three out of four of the SPADs 26 detect one photon of light scattered from the second laser pulse 42b resulting in a corresponding electrical pulse in SPAD signals SPADSignal1, SPADSignal2 and SPADSignal4, but no corresponding electrical pulse in SPAD signal SPADSigna13.

The processing resource 30 applies one or more time-shifts to the plurality of SPAD signals SPADSignal1-SPADSignal4 to compensate the plurality of SPAD signals SPADSignal1-SPADSignal4 for the differences between the arrival times of light scattered from the different regions of the scattering medium 8 onto the different SPADs 26 of the SPAD array 24. Specifically, as shown in FIG. 3C, the processing resource 30 selects SPAD signal SPADSignal1 detected by a first SPAD as a reference SPAD signal and applies a different time-shift to each of the one or more other SPAD signals SPADSignal2-SPADSignal4 so as to generate one or more time-shifted SPAD signals SPADSignal2′-SPADSignal4′. As may be appreciated from FIG. 3C, the time-shifts applied to the one or more other SPAD signals SPADSignal2-SPADSignal4 are selected so that the electrical pulses generated as a result of the detection of photons scattered from the optical pulses now line up. However, since background photons arrive at random times, the electrical pulses generated as a result of the detection of photons of background light also occur at random times such that it is unlikely that the electrical pulses generated as a result of the detection of photons of background light will line up once the time-shifts have been applied to the one or more other SPAD signals SPADSignal2-SPADSignal4.

The processing resource 30 then adds the reference SPAD signal SPADSignal1 and the one or more time-shifted photodetector signals SPADSignal2′-SPADSignal4′ together so as to generate a time-varying summed SPAD signal shown in FIG. 3D which includes clusters of electrical pulses around the times at which the first SPAD detected scattered light from each of the optical pulses 42a, 42b and 42c.

The processing resource 30 then cross-correlates a time window function 44 shown in FIG. 3E with the sum of the time-shifted SPAD signals shown in FIG. 3D to generate the optical receiver signal shown in FIG. 3F, wherein the time window function has a duration which is comparable to a duration of an arrival period of light which is scattered from each of the optical pulses 42a, 42b and 42c and received on the SPAD array 24. As may be appreciated from a comparison of the time-varying optical receiver signal shown in FIG. 3F with the time-varying intensity of the pulsed optical beam 4 shown in FIG. 3A, the time-varying optical receiver signal shown in FIG. 3F is representative of the time-varying intensity of the pulsed optical beam 4.

Although the method of determining the time-varying optical receiver signal representative of the time-varying intensity of the pulsed optical beam 4 was described above with reference to FIGS. 3A to 3F for the particular case of four SPADs 26, it should be understood that the SPAD array 24 may comprise less than four SPADs 26 or more than four SPADs 26 and that the method of determining the time-varying optical receiver signal representative of the time-varying intensity of the pulsed optical beam 4 may be adapted accordingly.

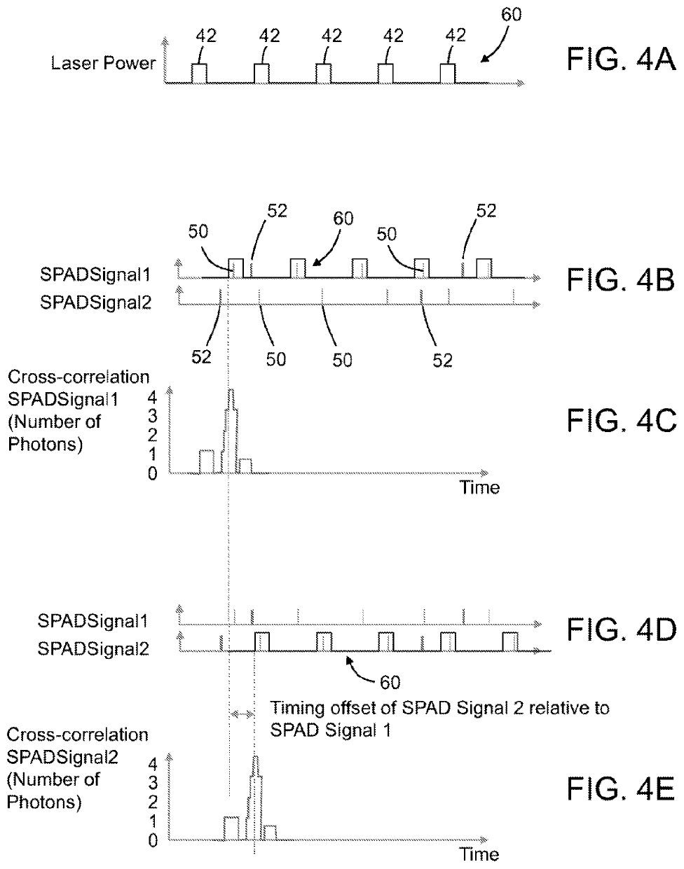

The method of selecting the different time-shifts will now be described with reference to FIGS. 4A to 4E. In effect, the method comprises determining the different time-shifts associated with the different SPADs 26 according to a speed at which the scattered light 10 from the different regions of the scattering medium 8 moves across the different SPADs 26 of the SPAD array 24.

FIG. 4A shows an example of the variation of the optical power of a pulsed optical calibration beam as a function of time in the form of a known calibration sequence 60 of optical pulses having a known constant pulse repetition rate. FIG. 4B shows the corresponding time-varying SPAD signals SPADSignal1 and SPADSignal2 detected by two of the SPADs 26 when the optical receiver 20 is aligned with the pulsed optical calibration beam so that the lens 28 images light scattered from each optical pulse 42 onto the SPAD array 24 so as to form an image of each optical pulse 42 on the SPAD array 24. As shown in FIG. 4B, each SPAD signal SPADSignal1 and SPADSignal2 includes electrical pulses 50, wherein each electrical pulse 50 is generated as a result of the arrival of a photon which is scattered from the pulsed optical calibration beam. Each SPAD signal SPADSignal1 and SPADSignal2 further includes further electrical pulses 52, wherein each further electrical pulse 52 is generated as a result of the arrival of a photon of background light.

The processing resource 30 then cross-correlates time-varying SPAD signal SPADSignal1 with the known calibration sequence 60 of the optical pulses 42 to generate a first cross-correlated calibration signal shown in FIG. 4C for the first SPAD. The processing resource 30 then determines the time-shift for the first SPAD from a timing of the peak value of the first cross-correlated calibration signal of FIG. 4C.

Similarly, as shown in FIG. 4D, the processing resource 30 cross-correlates time-varying SPAD signal SPADSignal2 with the same known calibration sequence 60 of the optical pulses 42 to generate a second cross-correlated calibration signal shown in FIG. 4E for the second SPAD. As indicated by the dashed lines in FIGS. 4B-4E, the processing resource 30 then determines the time-shift for the second SPAD relative to the time shift for the first SPAD from a timing of the peak value of the second cross-correlated calibration signal of FIG. 4E. Although the method of determining the different time-shifts for each SPAD 26 was described above with reference to FIGS. 4A to 4E for the particular case of two SPADs 26, it should be understood that the SPAD array 24 may comprise more than two SPADs 26 and that the method of determining the different time-shifts for each SPAD 26 may be adapted accordingly.

One of ordinary skill in the art will understand that the method for detecting the pulsed optical beam 4 described above may provide a greater contrast or a greater signal-to-noise ratio (SNR) than known methods for detecting pulsed optical beams not least because the different SPADs 26 of the SPAD array 24 detect the light which is scattered progressively from the same optical pulse 42 as the optical pulse 42 propagates through different regions of the scattering medium 8 and which is then received progressively on the different SPADs 26 of the SPAD array 24, thereby enabling a plurality of measurements of the light scattered from the same optical pulse 42 to be performed. As such, one of skill in the art will understand that increasing the number of SPADs 26 in the SPAD array 24 may increase the contrast or the SNR of the method for detecting the optical pulses 42 of the pulsed optical beam 4.

The contrast or SNR of the method for detecting the pulsed optical beam 4 described above is also dependent on a number of other factors. For example, the use of the spectral filter 27 may serve to reduce unwanted background light which is incident on the SPAD array 24. Moreover, the system 2 may be configured so that a width of the image of the light scattered from the pulsed optical beam 4 on the SPAD array 24 is comparable to, or equal to, a width of each SPAD 26 so as to minimise the detection of background light by the SPADs 26 of the SPAD array 24 from regions of the scattering medium either side of the pulsed optical beam 4. For example, for a given width of pulsed optical beam 4 and a given spatial arrangement of the optical transmitter 6 and the optical receiver 20, the configuration of the optical receiver 20 may be adjusted so that the width of the image of the light scattered from the pulsed optical beam 4 on the SPAD array 24 is comparable to, or equal to, a width of each SPAD 26.

Similarly, the system 2 may be configured so that a length of the image of the light scattered from each optical pulse 42 on the SPAD array 24 is comparable to, or equal to, a length of each SPAD 26. For example, for a given optical pulse duration and a given spatial arrangement of the optical transmitter 6 and the optical receiver 20, the configuration of the optical receiver 20 may be adjusted so that the length of the image of the light scattered from each optical pulse 42 on the SPAD array 24 is comparable to, or equal to, the length of each SPAD 26 so as to maximise the contrast or signal-to-noise ratio (SNR) when the scattered light from an optical pulse is imaged onto the centre of each SPAD 26.

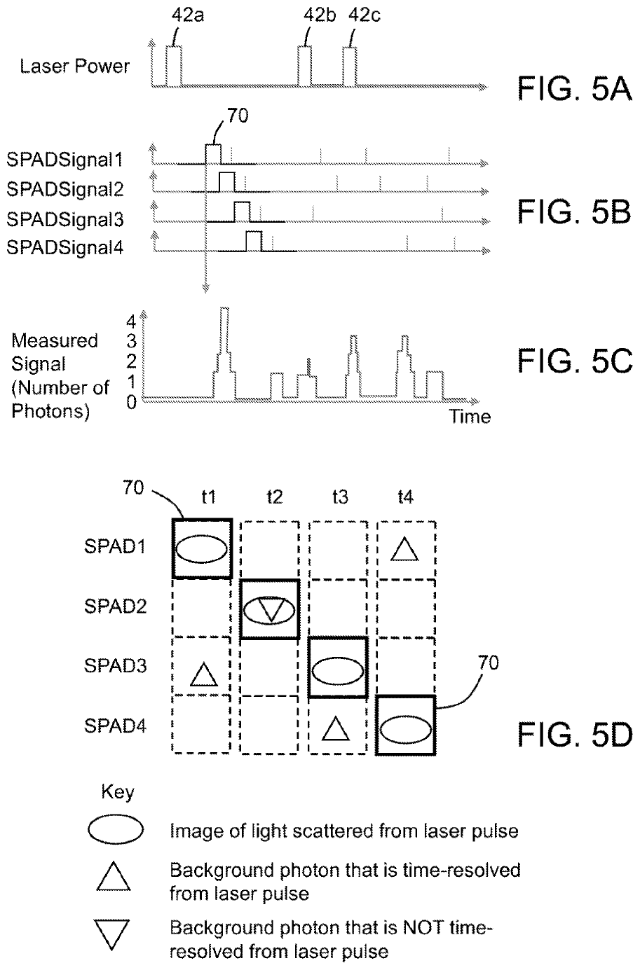

As will now be described with reference to FIGS. 5A-5D, the contrast or the SNR of the detection method may be further enhanced by cross-correlating each time-varying SPAD signal SPADSignal1-SPADSignal4 with a corresponding time-shifted window function 70 which has a duration which is selected to match a duration of an arrival period of the light scattered from each optical pulse 42a, 42b, 42c on each SPAD 26. FIG. 5A shows an example of the variation of the optical power of the pulsed optical beam 4 as a function of time in the form of a sequence of three different optical pulses 42a, 42b and 42c. FIG. 5B shows the corresponding time-varying SPAD signals SPADSignal1-SPADSignal4 detected by four of the SPADs 26 when the optical receiver 20 is aligned with the pulsed optical beam 4 so that the lens 28 images light scattered from the different optical pulses 42a, 42b, 42c onto the SPAD array 24. Also shown in FIG. 5B, are a plurality of different time-shifted time window functions 70, each time-shifted time window function 70 corresponding to a different one of the time-varying SPAD signals SPADSignal1-SPADSignal4. Each time-shifted time window function 70 is time-shifted relative to each of the other time-shifted time window functions 70 by the same time-shifts used to compensate the plurality of SPAD signals SPADSignal1-SPADSignal4 for the differences between the arrival times of light scattered from the different regions of the scattering medium 8 onto the different SPADs 26 of the SPAD array 24 as already described above with reference to FIGS. 3A-3F and 4A-4E. Moreover, each time-shifted time window function 70 is cross-correlated with the corresponding time-varying SPAD signal SPADSignal1-SPADSignal4 to determine a corresponding cross-correlated SPAD signal and the cross-correlated SPAD signals are summed to generate the time-varying optical receiver signal representative of the time-varying intensity of the pulsed optical beam 4 shown in FIG. 5C. As may be appreciated from a comparison of the time-varying optical receiver signal representative of the time-varying intensity of the pulsed optical beam 4 shown in FIGS. 3F and 5C, the method of determining the time-varying optical receiver signal representative of the time-varying intensity of the pulsed optical beam 4 described with reference to FIGS. 5A-5C is completely equivalent to the method of determining the time-varying optical receiver signal representative of the time-varying intensity of the pulsed optical beam 4 described with reference to FIGS. 3A-3F.

FIG. 5D illustrates the movement of an image of light scattered from any one of optical pulses 42a, 42b, 42c along four different SPADs, SPAD1-SPAD4 of the SPAD array 24 as said optical pulse moves along the optical path 40. At a first time t1, the image of the scattered light is located on a first SPAD, SPAD1. At a second time t2, the image of the scattered light is located on a second SPAD, SPAD2. At a third time t3, the image of the scattered light is located on a third SPAD, SPAD3. At a fourth time t4, the image of the scattered light is located on a fourth SPAD, SPAD4. Also shown in FIG. 5D are background photons incident on the different SPADs, SPAD1-SPAD4 at random times. Specifically, a first background photon arrives on SPAD1 at time t4, a second background photon arrives on SPAD2 at time t2, a third background photon arrives on SPAD3 at time t1, and a fourth background photon arrives on SPAD4 at time t3. Also shown in FIG. 5D are the time-shifted time window functions 70 for the case when the time-shifted time window functions 70 coincide with the arrival period of the light scattered from said optical pulse on each SPAD, SPAD1-SPAD4 resulting in the largest peak in the time-varying optical receiver signal shown in FIG. 5C. As may be appreciated from FIG. 5D, the only background photon which contributes to the largest peak in the time-varying optical receiver signal shown in FIG. 5C is the second background photon which arrives on SPAD2 at the same time t2 as the light scattered from said optical pulse. Furthermore, the other background photons arriving at SPAD1 at time t4, arriving at SPAD3 at time t1, and arriving at SPAD4 at time t3, only contribute to the time-varying optical receiver signal shown in FIG. 5C at times when the time-shifted time window functions 70 are shifted in time so that the time-shifted time window functions 70 no longer coincide with the arrival time of the light scattered from said optical pulse on each SPAD, SPAD1-SPAD4. In effect, this means that the other background photons only contribute to background noise artefacts or features in the time-varying optical receiver signal shown in FIG. 5C between the peaks in the time-varying optical receiver signal which correspond to the arrival of light scattered from the optical pulses 42a, 42b and 42c. In other words, the use of the time-shifted time window functions 70, serves to time-resolve the arrival of many of the photons of background light from the arrival of the photons of light which is scattered from the optical pulses 42a, 42b and 42c and then imaged onto the SPAD array 24.

The impact of the background noise artefacts or features in the time-varying optical receiver signal shown in FIG. 5C is reduced by having time-shifted window functions 70 that have a duration which is selected to match an arrival period of the light scattered from each optical pulse 42a, 42b, 42c on each SPAD 26. The amplitude of the background noise artefacts or features in the time-varying optical receiver signal shown in FIG. 5C is determined by the number of background photons that are detected within a time period equal to the duration of the time-shifted window functions 70. This may be understood to be because the time-varying optical receiver signal shown in FIG. 5C is constructed by performing a cross-correlation between the time-shifted window functions 70 and the SPAD signals SPADSignal1 to SPADSignal4 in FIG. 5B. The amplitude of the time-varying optical receiver signal shown in FIG. 5C at any point in time is determined by the number of photons that were detected within the time periods defined by each of the time-shifted window functions 70. As background photons generally arrive at random times, with substantially uniform probability, the average contribution to the time varying optical receiver signal shown in FIG. 5C from background photons is proportional to the duration of the time-shifted window functions 70. Therefore, using time-shifted window functions 70 that each have a duration which is selected to match an arrival period of the light scattered from each optical pulse 42a, 42b, 42c on each SPAD 26 has the advantage that it reduces the average contribution to the time varying optical receiver signal that comes from background photons. This improves the ability of the optical receiver 20 to detect signal photons that are emitted from the optical transmitter 6 and scattered by the scattering medium 8. In effect, the method for detecting the pulsed optical beam 4 described above allows the use of short-duration time-shifted window functions 70, without substantially reducing the number of scattered photons detected by the optical receiver 20. This may enhance the contrast or the SNR of the method for detecting the pulsed optical beam 4.

As described above, the duration of the time-shifted window functions is selected to match an arrival period of the light scattered from any one of the optical pulses 42a, 42b, 42c on each SPAD 26. This may be achieved by trying a range of different time-shifted window function durations and selecting the duration that maximises the SNR at the optical receiver 20. If the duration is too short, then some of the photons scattered from an optical pulse are not summed at the optical receiver 20 (as they arrive at times that are too-widely separated) and the SNR is reduced. If the duration is too long then additional background photons are unnecessarily summed into the photon count and the SNR is reduced. Accordingly, the SNR is maximised when the time-window duration matches the arrival period of light which is scattered from any one of the optical pulses 42a, 42b, 42c.

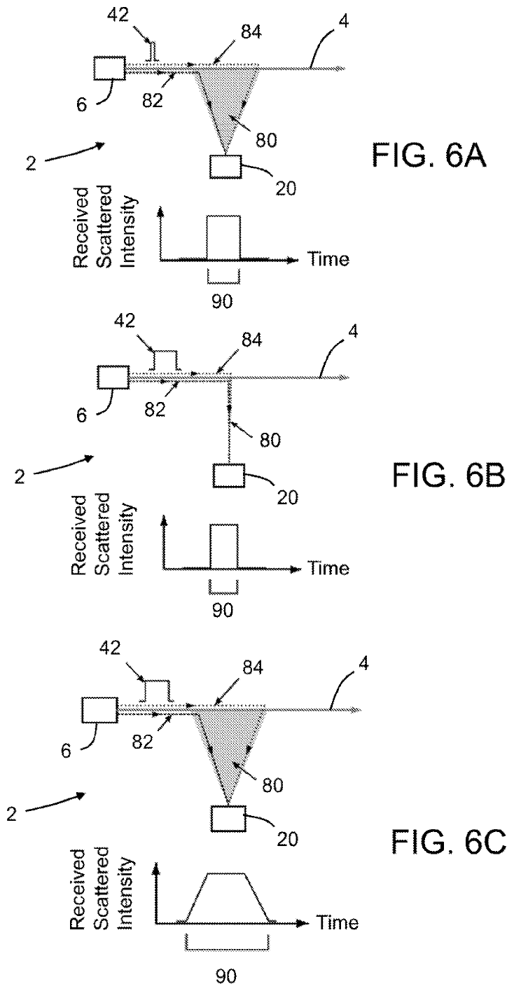

As an alternative to trying a range of different time-shifted window function durations and selecting the duration that maximises the SNR at the optical receiver 20, the duration of the time-shifted window functions 70 may be selected based on the arrival period of the light scattered from any one of the optical pulses 42a, 42b, 42c on each SPAD 26 of the optical receiver 20. As will now be described with reference to FIGS. 6A-6C below, the arrival period 90 of the light scattered from any one of the optical pulses 42a, 42b, 42c on each SPAD 26 of the optical receiver 20 depends on the duration of each optical pulse 42a, 42b, 42c and the field-of-view (FOV) 80 of each individual SPAD 26. It should be understood that the FOV 80 of each individual SPAD 26 depends on the size of an individual SPAD 26 and the relative spatial arrangement of the lens 28, and the SPAD array 24. The duration of the optical pulses 42a, 42b, 42c will typically be known, as this will have been designed into the system beforehand. The time taken for an optical pulse 42a, 42b, 42c to traverse the FOV 80 of a SPAD 26 depends upon the distance between the receiver 20 and the path 4 of the optical pulses 42a, 42b, 42c, which could vary and therefore needs to be measured on a case-by-case basis.

For example, FIG. 6A shows the optical system 2 for the case where the optical transmitter 6 emits a pulsed optical beam 4 comprising a shorter optical pulse 42 and each individual SPAD 26 has a wider FOV 80. Light which is scattered from the optical pulse 42 within the FOV 80 is received by the corresponding SPAD 26. The scattered light which is received by the corresponding SPAD 26 follows an optical path which has a length which is greater than or equal to the length of the shortest optical path 82 and which is less than or equal to the length of the longest optical path 84. For the case shown in FIG. 6A, the optical pulse 42 is so short and the FOV 80 of each individual SPAD 26 is so wide that the arrival period 90 of the scattered light on the SPAD 26 is essentially determined by the difference between the arrival time of scattered light which has travelled along the longest optical path 84 and the arrival time of scattered light which has travelled along the shortest optical path 82.

FIG. 6B shows the optical system 2 for the case where the optical transmitter 6 emits a pulsed optical beam 4 comprising a longer optical pulse 42 and each individual SPAD 26 has a narrower FOV 80. For the case shown in FIG. 6B, the optical pulse 42 is so long and the FOV 80 of each individual SPAD 26 is so narrow that the arrival period 90 of the scattered light on the SPAD 26 is essentially determined by the duration of the optical pulse 42.

FIG. 6C shows the optical system 2 for the case where the optical transmitter 6 emits a pulsed optical beam 4 comprising a longer optical pulse 42 and each individual SPAD 26 has a wider FOV 80. For the case shown in FIG. 6C, the optical pulse 42 is so long and the FOV 80 of each individual SPAD 26 is so wide that the arrival period 90 of the scattered light on the SPAD 26 is determined by the difference between the arrival time of scattered light which has travelled along the longest optical path 84 and the arrival time of scattered light which has travelled along the shortest optical path 82 in combination with the duration of the optical pulse 42.

The time taken for an optical pulse 42a, 42b, 42c to traverse the FOV 80 of an individual SPAD 26 of the SPAD array 24 may be determined from knowledge of the time delay between observing the optical pulse 42a, 42b, 42c on adjacent SPADs 26 of the SPAD array 24. For example, if the individual SPADs 26 are arranged in a uniform SPAD array 24 with no gaps between them (i.e. the spacing of the SPADs 26 of the SPAD array 24 is equal to a dimension of an active area of each SPAD 26) then the time delay between observing a signal on one SPAD 26 of the SPAD array 24 and observing a signal on the next adjacent SPAD 26 of the SPAD array 24 will be equal to the time for the optical pulse 42a, 42b, 42c to traverse the FOV 80 of a single SPAD 26 of the SPAD array 24.

The method for detecting the pulsed optical beam 4 described above may be used for a number of different technical applications and in particular, though not exclusively, for NLOS free-space optical communications (FSOC) between the optical transmitter 6 and the optical receiver 20. To enable NLOS FSOC between the optical transmitter 6 and the optical receiver 20, the plurality of optical pulses of the pulsed optical beam 4 may be configured so as to carry or encode data or information and the processing resource 30 may be configured to extract or decode the data or information carried by, or encoded in, the plurality of optical pulses from the determined time-varying optical receiver signal such as the determined time-varying optical receiver signal shown in FIG. 3F. For example, as shown in FIG. 3A, the timing of the optical pulses may be varied so as to carry or encode data or information using Pulse Position Modulation (PPM) and the processing resource 30 may be configured to extract or decode the data or information carried by, or encoded in, the timing of the optical pulses from the determined time-varying optical receiver signal shown in FIG. 3F. As a result of the enhanced contrast or the improved SNR of the method for detecting the pulsed optical beam 4 described above, NLOS FSOC may be achieved over a greater range than prior art NLOS FSOC methods, even in daylight.

In other FSOC methods, data or information may be carried or encoded using a pulse analogue modulation method of a kind other than PPM such as Pulse Amplitude Modulation (PAM) or Pulse Width Modulation (PWM). In other FSOC methods, data or information may be carried or encoded using a pulse code modulation (PCM) method such as on/off keying, return-to-zero signalling or the like. Furthermore, as will be understood by one of ordinary skill in the art, cross-correlating a time window function 44 with the sum of time-shifted SPAD signals to generate a time-varying optical receiver signal as described above with reference to FIGS. 3A-3F or summing cross-correlated SPAD signals generated by cross-correlating time-shifted time window functions 70 with time-varying SPAD signals to generate a time-varying optical receiver signal as described above with reference to FIGS. 5A-5C serves to time-resolve the arrival of the photons of light scattered from a plurality of optical pulses 42a, 42b, 42c. In the context of FSOC, this improved timing resolution allows for higher data rates. For example, if transmitting data using on/off keying then bits can simply be sent at a faster rate compared to a system with worse timing resolution. Or, if using pulse position modulation (PPM), then each optical pulse could potentially occupy a larger number of (shorter duration) time slots, allowing information to be transmitted at higher data rates.

It should also be understood that use of a pulsed optical beam comprising UV-B light, UV-A light, visible light or infra-red (IR) light may result in an increased fraction of scattered light being Mie scattering which is more directional than the scattering which occurs when using UV-C light, thereby making it harder for an adversary to detect the pulsed optical beam, especially when the optical receiver 20 is positioned close to the pulsed optical beam 4. This may be important for secure communications.

In a further technical application, the method for detecting the pulsed optical beam 4 described above may be used for determining one or more properties of the scattering medium 8. For example, the method may comprise transmitting a pulsed optical beam comprising a plurality of optical pulses having a known probe sequence through the scattering medium 8 and using the known probe sequence and the determined time-varying optical receiver signal to determine one or more properties of the scattering medium 8.

As will be appreciated by one of skill in the art, the methods described above assume that the SPAD array 24 is aligned relative to the optical path 40 of the pulsed optical beam 4 so that the plurality of SPADs 26 of the SPAD array 24 are capable of receiving light which is scattered from the pulsed optical beam 4 as the pulsed optical beam 4 propagates through the corresponding plurality of regions of the scattering medium 8. In practice, the optical path 40 of the pulsed optical beam 4 through the scattering medium 8 may be known with sufficient accuracy a priori so that the SPAD array 24 may simply be aligned relative to the known optical path 40.

However, where the optical path 40 of the pulsed optical beam 4 is unknown or is only known to a limited degree of accuracy, it is necessary to align the SPAD array 24 relative to the optical path 40 of the pulsed optical beam 4 in order to detect the pulsed optical beam 4. For example, aligning the SPAD array 24 relative to the pulsed optical beam 4 may comprise:
(i) transmitting a pulsed optical alignment beam through the scattering medium 8, the pulsed optical alignment beam comprising a known alignment sequence of optical pulses;
(ii) aligning the SPAD array 24 so as to receive, on the plurality of SPADs 26 of the SPAD array 24, light from a corresponding plurality of different regions of the scattering medium 8 arranged along a trial optical path while the pulsed optical alignment beam is propagating through the scattering medium 8;
(iii) for each SPAD 26 of the SPAD array 24:
   detecting the light received on the SPAD 26 from the corresponding region of the scattering medium 8 as a function of time to generate a corresponding time-varying SPAD alignment signal;
   cross-correlating the SPAD alignment signal with the known alignment sequence of optical pulses of the pulsed optical alignment beam to generate a cross-correlated alignment signal; and
   determining a peak value of the cross-correlated alignment signal;
(iv) repeating steps (ii) and (iii) for a plurality of different trial optical paths; and
(v) aligning the SPAD array 24 so as to receive, on the plurality of SPADs 26 of the SPAD array 24, light from the corresponding plurality of different regions of the scattering medium 8 which are arranged along the trial optical path which optimises or maximises the peak value of one or more of the cross-correlated alignment signals.

The pulsed optical alignment beam may, for example, be the same as the pulsed optical calibration beam and/or the known alignment sequence of optical pulses may be the same as the known calibration sequence of optical pulses.

Aligning the SPAD array 24 relative to the pulsed optical beam 4 may allow the pulsed optical beam 4 to be detected. This may have applications for the detection of pulsed optical beams such as a pulsed laser beam of a laser range finder, a pulsed laser beam of a laser target designator, or a pulsed laser beam of a FSOC system such as a LOS FSOC system or a NLOS FSOC system.

One of ordinary skill in the art will also understand that various modifications are possible to any of the methods described above. For example, although the width of the image of the light scattered from the pulsed optical beam 4 on the SPAD array 24 is described as being comparable to, or equal to, a width of each SPAD 26, in other embodiments of the optical system 2, the width of the image of the light scattered from each optical pulse 42 on the SPAD array 24 may be greater than a width of each SPAD 26 of the SPAD array 24 i.e. the width of each SPAD 26 may be less than a width of the image of the light scattered from each optical pulse 42.

Although the length of the image of the light scattered from each optical pulse 42 on the SPAD array 24 is described as being comparable to, or equal to, a length of each SPAD 26 of the SPAD array 24 with reference to FIG. 5D, in other embodiments of the optical system 2, the length of the image of the light scattered from each optical pulse 42 on the SPAD array 24 may be greater than a length of each SPAD 26 of the SPAD array 24 i.e. the length of each SPAD 26 may be shorter than the length of the image of the light scattered from each optical pulse 42. In effect, this may mean that an image of the light scattered from each optical pulse 42 is incident simultaneously on more than one of the SPADs 26 of the SPAD array 24. However, since it is technically more difficult to implement smaller SPADs 26, reducing the length of each SPAD 26 relative to the length of the image of the light scattered from each optical pulse 42 may be a waste of engineering effort.

Although the optical receiver 20 is described above as including a SPAD array 24, in other embodiments, the optical receiver 20 may include a single-photon detector array of any kind. In further embodiments, the optical receiver 20 may include a photodetector array other than a single-photon detector array. For example, the optical receiver 20 may include a photodiode array such as a fast photodiode array. One of skill in the art will understand that, in contrast to an array of single-photon detectors which each generate a series of discrete electrical pulses on the arrival of photons on the single-photon detector, each photodetector of a photodetector array, such as each photodiode of a photodiode array, may generate a corresponding photodetector signal which varies continuously in time according to the intensity of the light received by the photodetector. Accordingly, when using a photodetector array such as a photodiode array in the optical receiver in place of the SPAD array 24, there is no need to cross-correlate a time window function like the time window function 44 with a summed photodetector signal to generate the optical receiver signal representative of the time-varying intensity of the pulsed optical beam. Specifically, when using a photodetector array such as a photodiode array in the optical receiver in place of the SPAD array 24, the method may comprise detecting the scattered light received on each photodetector from the corresponding region of the scattering medium as a function of time so as to generate a corresponding time-varying photodetector signal, and using the plurality of photodetector signals to determine a time-varying optical receiver signal representative of a time-varying intensity of the pulsed optical beam. Moreover, using the plurality of photodetector signals to determine the optical receiver signal may comprise applying one or more time-shifts to the plurality of photodetector signals to compensate the plurality of photodetector signals for differences between the arrival times of light scattered from the different regions of the scattering medium onto the different photodetectors of the photodetector array. For example, applying the one or more time-shifts to the plurality of photodetector signals to compensate the plurality of photodetector signals for differences between the arrival times of light from the different regions of the scattering medium onto the different photodetectors of the photodetector array may comprise selecting one of the photodetector signals as a reference photodetector signal and applying a different time-shift to each of the one or more other photodetector signals so as to generate one or more time-shifted photodetector signals. Using the plurality of photodetector signals to determine the optical receiver signal may further comprise adding the reference photodetector signal and the one or more time-shifted photodetector signals together so as to generate a time-varying summed photodetector signal, wherein the summed photodetector signal is the optical receiver signal representative of the time-varying intensity of the pulsed optical beam.

Although the photodetector array of the optical receiver 20 comprises a linear array of photodetectors in the form of a linear array 24 of SPADs 26, in other embodiments, the photodetector array may comprise a 2D array of photodetectors. Use of a 2D array of photodetectors may help to align the photodetector array relative to the pulsed optical beam, for example by relaxing the alignment tolerances between the photodetector array and the pulsed optical beam. In the case, the 2D photodetector array does not need to be aligned to the laser beam with precision but instead it just needs to be determined which photodetectors are collecting light from the pulsed optical beam, and which are not, so that the photodetector signals from the correct photodetectors can be combined to generate the time-varying optical receiver signal which is representative of the time-varying intensity of the pulsed optical beam.

Although the optical receiver is described above as including an imaging system in the form of the lens 28, in an alternative embodiment, any kind of imaging system may be used. For example, the imaging system may comprise one or more lenses and/or one or more curved mirrors. In another embodiment, the optical receiver may not include an imaging system of any kind. For example, the optical receiver may include one or more pinhole apertures rather than an imaging system.

The optical transmitter 6 may generate pulses of UV-B light or pulses of UV-A light or pulses of visible light or pulses of IR light such as pulses of near-IR light, short-wavelength IR light, or mid-IR light and the optical receiver may be configured accordingly. Use of a pulsed optical beam comprising UV-B light or UV-A light or visible light or IR light may allow communications over greater distances than the use of a pulsed optical beam of UV-C light. Use of a pulsed optical beam comprising UV-B light, UV-A light, visible light or IR light may result in an increased fraction of scattered light being Mie scattering which is more directional than the scattering which occurs when using UV-C light, thereby making it harder for an adversary to detect the pulsed near-IR optical beam.

The method may comprise modulating a direction of the pulsed optical beam. A potential advantage of doing this includes transmitting more information. This may also make it harder for an adversary to detect or intercept a communication. For example, the method may comprise modulating a pitch of the pulsed optical beam by angling the pulsed optical beam upwardly or downwardly. This may, for example, be advantageous where the pulsed optical beam passes directly over the top of the optical receiver. Angling the pulsed optical beam slightly up or down will have little effect upon the time-varying optical receiver signal representative of the time-varying intensity of the pulsed optical beam detected at the optical receiver because the image of the pulsed optical beam will stay in the same place on an image plane of the optical receiver, and there will be a very small variation in the timing of the received scattered light which could either be ignored if it is small enough, or compensated for in the analysis of the time-varying optical receiver signal. However, an adversary that is attempting to detect or intercept the communication will see a moving pulsed optical beam (unless they are on a direct line between the optical transmitter and the optical receiver), and this will make it harder to detect or intercept the signal because the adversary's optical receiver would have to compensate for the motion of the pulsed optical beam, whereas the legitimate optical receiver of the communication does not have to compensate for the motion of the pulsed optical beam.

The method may comprise modulating a yaw of the pulsed optical beam. Again, consider a situation where the pulsed optical beam passes directly over the top of the optical receiver. If the yaw of the pulsed optical beam is modulated, the optical receiver will see the pulsed optical beam moving on the image plane. If the optical receiver has a 2D photodetector array then both the timing of the optical pulses and the direction of the optical pulses can be recorded.

The method may comprise using the direction of the pulsed optical beam to encode additional information.

The method may comprise transmitting one or more additional optical beams which are additional to the pulsed optical communication beam used for communication.

For example, method may comprise transmitting additional optical beams to the left and/or right of the pulsed optical communication beam, wherein the pulsed optical communication beam passes directly over the top of the optical receiver. The legitimate optical receiver can ignore these additional beams, as their images fall upon different locations on the image plane in which the photodetector array is located. However, an adversary that is far enough away from a direct line between the optical transmitter and the optical receiver will receive scattered light from both the pulsed optical communication beam and these additional optical beams upon the same part of the image plane of the adversary's optical receiver. This reduces the signal to background light ratio for the adversary's optical receiver (where the additional optical beams are considered to produce background light in this case). The method may comprise deliberately modulating a direction of, and/or encoding data on, the additional optical beams to produce a signal that is confusing for an adversary trying to intercept the signal, for example with a similar type of modulation but different transmitted data—so that the adversary's optical receiver cannot tell which light came from the pulsed optical communication beam and which light came from the additional optical beams.

The method may comprise modulating a direction of the pulsed optical beam using a plurality of pulsed optical sources, wherein each pulsed optical source is configured to transmit a corresponding pulsed optical beam in a different direction at a different time. For example, an array of optical sources may be placed one focal length away from a collimating lens.

Additionally or alternatively, the direction of the pulsed optical beam may be modulated using a fast-moving mirror.

Additionally or alternatively, the direction of the pulsed optical beam may be modulated using a fast optical switch to direct light to different outputs, each of which transmits the pulsed beam in a corresponding different direction.

Additionally or alternatively, the method may comprise modulating a divergence of the pulsed optical beam, for example using an elliptical lens.

The method may comprise using Wavelength Division Multiplexing (WDM) to increase the transmitted data rate. Specifically, the pulsed optical beam may comprise a plurality of different carrier wavelengths with a different stream of data encoded on each carrier wavelength and the method may comprise separating the different carrier wavelengths onto different photodetectors. The optical receiver may, for example, include a dispersive element such as a prism or diffraction grating for this purpose.

Although the disclosure has been described in terms of preferred embodiments as set forth above, it should be understood that these embodiments are illustrative only and that the claims are not limited to those embodiments. Those skilled in the art will be able to make modifications and alternatives to the described embodiments in view of the disclosure which are contemplated as falling within the scope of the appended claims. Each feature disclosed or illustrated in the present specification may be incorporated in any embodiment, whether alone or in any appropriate combination with any other feature disclosed or illustrated herein. In particular, one of ordinary skill in the art will understand that one or more of the features of the embodiments of the present disclosure described above with reference to the drawings may produce effects or provide advantages when used in isolation from one or more of the other features of the embodiments of the present disclosure and that different combinations of the features are possible other than the specific combinations of the features of the embodiments of the present disclosure described above.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Use of the term “comprising” when used in relation to a feature of an embodiment of the present disclosure does not exclude other features or steps. Use of the term “a” or “an” when used in relation to a feature of an embodiment of the present disclosure does not exclude the possibility that the embodiment may include a plurality of such features.

The use of reference signs in the claims should not be construed as limiting the scope of the claims.

1. A method for use in detecting a pulsed optical beam comprising a plurality of optical pulses when the pulsed optical beam is transmitted through a scattering medium, wherein the pulsed optical beam comprises UV-B light, UV-A light, visible light, or infra-red (IR) light, and wherein the method comprises:
using a plurality of photodetectors of a photodetector array to detect light which is scattered progressively from the same optical pulse as the optical pulse propagates through a plurality of regions of the scattering medium and which is then received progressively on different photodetectors of the photodetector array;
detecting the scattered light received on each photodetector from the corresponding region of the scattering medium as a function of time so as to generate a corresponding time-varying photodetector signal; and
using the plurality of photodetector signals to determine a time-varying optical receiver signal representative of a time-varying intensity of the pulsed optical beam,
wherein using the plurality of photodetector signals to determine the optical receiver signal comprises:
selecting one of the photodetector signals as a reference photodetector signal; applying a different time-shift to each of the one or more other photodetector signals so as to generate one or more time-shifted photodetector signals;
adding the reference photodetector signal and the one or more time-shifted photodetector signals together so as to generate a time-varying summed photodetector signal; and
cross-correlating a time window function with the summed photodetector signal to generate the optical receiver signal representative of the time-varying intensity of the pulsed optical beam, wherein the time window function has a duration which is at least one of selected to time-resolve the arrival of many photons of background light from the arrival of photons of light which are scattered from each optical pulse and received on the photodetector array or selected to match an arrival period of light which is scattered from each optical pulse and received on the photodetector array; or
wherein using the plurality of photodetector signals to determine the optical receiver signal comprises:
cross-correlating different time-shifted time window functions with the different photodetector signals to generate a plurality of time-shifted cross-correlated photodetector signals; and
adding the plurality of time-shifted cross-correlated photodetector signals so as to generate a time-varying summed photodetector signal, wherein the time-varying summed photodetector signal is the optical receiver signal representative of the time-varying intensity of the pulsed optical beam, wherein each of the time-shifted time window functions has a duration which is at least one of selected to time-resolve the arrival of many photons of background light from the arrival of photons of light which are scattered from each optical pulse and received on the photodetector array or selected to match an arrival period of light which is scattered from each optical pulse and received on the photodetector array.

2. The method as claimed in claim 1, further comprising using the plurality of photodetectors of the photodetector array to detect light which is scattered progressively from each optical pulse as each optical pulse propagates through the plurality of regions of the scattering medium and which is then received progressively on different photodetectors of the photodetector array.

3. The method as claimed in claim 1, further comprising at least one of:
imaging each region of the plurality of regions of the scattering medium onto a corresponding photodetector of the photodetector array; or
imaging light scattered from each optical pulse onto the photodetector array so as to form an image of each optical pulse on the photodetector array, wherein the image of the light scattered from each optical pulse moves progressively along the different photodetectors of the photodetector array as a result of the propagation of each optical pulse through the plurality of regions of the scattering medium.

4. The method as claimed in claim 1, wherein each of the one or more time window functions has a duration which is comparable to, or equal to, a duration of an arrival period of light which is scattered from each optical pulse and received on the photodetector array.

5. The method as claimed in claim 1, further comprising determining the different time-shifts associated with the different photodetectors according to a speed at which the light scattered from the different regions of the scattering medium moves across the different photodetectors of the photodetector array.

6. The method as claimed in claim 5, wherein the determining the different time-shifts associated with the different photodetectors further comprises:
transmitting a pulsed optical calibration beam through the scattering medium, the pulsed optical calibration beam comprising a known calibration sequence of optical pulses; and
for each photodetector of the photodetector array:
detecting light which is scattered from the pulsed optical calibration beam as the pulsed optical calibration beam propagates through the corresponding plurality of different regions of the scattering medium and received on the photodetector to generate a corresponding time-varying photodetector calibration signal;
cross-correlating the photodetector calibration signal with the known calibration sequence of optical pulses of the pulsed optical calibration beam to generate a cross-correlated calibration signal; and
determining the time-shift for the photodetector from a timing of a peak value of the cross-correlated calibration signal.

7. The method as claimed in claim 1, further comprising aligning the photodetector array relative to the pulsed optical beam so that the plurality of photodetectors of the photodetector array are capable of receiving light which is scattered from the pulsed optical beam as the pulsed optical beam propagates through the corresponding plurality of regions of the scattering medium.

8. The method as claimed in claim 7, wherein the aligning the photodetector array relative to the pulsed optical beam further comprises:
(i) transmitting a pulsed optical alignment beam through the scattering medium, the pulsed optical alignment beam comprising a known alignment sequence of optical pulses;
(ii) aligning the photodetector array so as to receive, on the plurality of photodetectors of the photodetector array, light from a corresponding plurality of different regions of the scattering medium arranged along a trial optical path while the pulsed optical alignment beam is propagating through the scattering medium;
(iii) for each photodetector of the photodetector array:
detecting the light received on the photodetector from the corresponding region of the scattering medium as a function of time to generate a corresponding time-varying photodetector alignment signal;
cross-correlating the photodetector alignment signal with the known alignment sequence of optical pulses of the pulsed optical alignment beam to generate a cross-correlated alignment signal; and
determining a peak value of the cross-correlated alignment signal;
iv) repeating steps (ii) and (iii) for a plurality of different trial optical paths; and
(v) aligning the photodetector array so as to receive, on the plurality of photodetectors of the photodetector array, light from the corresponding plurality of different regions of the scattering medium which are arranged along the trial optical path which optimises or maximises the peak value of one or more of the cross-correlated alignment signals.

9. The method as claimed in claim 1, wherein the photodetector array is arranged relative to the pulsed optical beam so that a length of the image of the light scattered from each optical pulse on the photodetector array is greater than, or comparable to, or equal to, a length of each photodetector.

10. The method as claimed in claim 1, wherein the photodetector array is arranged relative to the pulsed optical beam so that a width of the image of the light scattered from the pulsed optical beam on the photodetector array is greater than, or comparable to, or equal to, a width of each photodetector.

11. The method as claimed in claim 1, further comprising spectrally filtering light received from the scattering medium before the light is incident on the plurality of photodetectors of the photodetector array so as to remove background light at a wavelength which falls outside a spectral bandwidth of the pulsed optical beam.

12. A method for non-line-of-sight free-space optical communications comprising:
transmitting a pulsed optical beam through the scattering medium, the pulsed optical beam comprising a plurality of optical pulses, wherein the plurality of optical pulses of the pulsed optical beam are configured so as to carry or encode data or information; and
the method for use in detecting a pulsed optical beam as claimed in claim 1; and
extracting or decoding the data or information carried by, or encoded in, the plurality of optical pulses from the determined time-varying optical receiver signal.

13. The method as claimed in claim 12, at least one of:
wherein the plurality of optical pulses of the pulsed optical beam are configured to carry or encode the data or information according to a modulation or encoding scheme having a peak to average power ratio of 100 or more, 1,000 or more or 10,000 or more, or
wherein the data or information is carried or encoded using at least one of:
a pulse analogue modulation method such as Pulse Position Modulation (PPM), Pulse Amplitude Modulation (PAM) or Pulse Width Modulation (PWM); or
a pulse code modulation (PCM) method such as on/off keying or return-to-zero signalling.

14. The method as claimed in claim 12, further comprising at least one of:
modulating a direction of the pulsed optical beam;
transmitting one or more additional optical beams which are additional to the pulsed optical beam used for communication;
modulating a direction of, and/or encoding data on, the one or more additional optical beams;
modulating a direction of the pulsed optical beam using a plurality of pulsed optical sources, wherein each pulsed optical source is configured to transmit a corresponding pulsed optical beam in a different direction at a different time; or
modulating a divergence of the pulsed optical beam.

15. The method as claimed in claim 12, further comprising using Wavelength Division Multiplexing (WDM) to increase the transmitted data rate, wherein the pulsed optical beam comprises a plurality of different carrier wavelengths with a different stream of data encoded on each carrier wavelength, and wherein the method further comprises separating the different carrier wavelengths onto different photodetectors.

16. A method for determining one or more properties of a scattering medium, comprising:
transmitting a pulsed optical beam through the scattering medium, the pulsed optical beam comprising a plurality of optical pulses having a known probe sequence;
the method for use in detecting a pulsed optical beam as claimed in claim 1;
detecting the scattered light received on each photodetector from the corresponding region of the scattering medium as a function of time so as to generate a corresponding time-varying photodetector signal;
using the plurality of photodetector signals to determine a time-varying optical receiver signal representative of a time-varying intensity of the pulsed optical beam; and
using the known probe sequence and the determined time-varying optical receiver signal to determine one or more properties of the scattering medium.

17. An optical receiver for use in detecting a pulsed optical beam which comprises a plurality of optical pulses when the pulsed optical beam is transmitted through a scattering medium, wherein the pulsed optical beam comprises UV-B light, UV-A light, visible light, or infra-red (IR) light, and wherein the optical receiver comprises:
a photodetector array which includes a plurality of photodetectors,
wherein the optical receiver is arranged so that the plurality of photodetectors of the photodetector array detect light which is scattered progressively from the same optical pulse as the optical pulse propagates through a plurality of regions of the scattering medium and which is then received progressively on different photodetectors of the photodetector array, and
wherein the optical receiver is configured for:
detecting the scattered light received on each photodetector from the corresponding region of the scattering medium as a function of time so as to generate a corresponding time-varying photodetector signal; and
using the plurality of photodetector signals to determine a time-varying optical receiver signal representative of a time-varying intensity of the pulsed optical beam,
wherein using the plurality of photodetector signals to determine the optical receiver signal comprises:
selecting one of the photodetector signals as a reference photodetector signal;
applying a different time-shift to each of the one or more other photodetector signals so as to generate one or more time-shifted photodetector signals;
adding the reference photodetector signal and the one or more time-shifted photodetector signals together so as to generate a time-varying summed photodetector signal; and
cross-correlating a time window function with the summed photodetector signal to generate the optical receiver signal representative of the time-varying intensity of the pulsed optical beam, wherein the time window function has a duration which is at least one of selected to time-resolve the arrival of many photons of background light from the arrival of photons of light which are scattered from each optical pulse and received on the photodetector array or selected to match an arrival period of light which is scattered from each optical pulse and received on the photodetector array; or
wherein using the plurality of photodetector signals to determine the optical receiver signal comprises:
cross-correlating different time-shifted time window functions with the different photodetector signals to generate a plurality of time-shifted cross-correlated photodetector signals; and
adding the plurality of time-shifted cross-correlated photodetector signals so as to generate a time-varying summed photodetector signal, wherein the time-varying summed photodetector signal is the optical receiver signal representative of the time-varying intensity of the pulsed optical beam, wherein each of the time-shifted time window functions has a duration which is at least one of selected to time-resolve the arrival of many photons of background light from the arrival of photons of light which are scattered from each optical pulse and received on the photodetector array or selected to match an arrival period of light which is scattered from each optical pulse and received on the photodetector array.

18. An optical system comprising:
the optical receiver as claimed in claim 17; and
an optical transmitter for transmitting the pulsed optical beam through the scattering medium to thereby cause light from each optical pulse to be scattered by the scattering medium when each optical pulse propagates through the plurality of different regions of the scattering medium.

19. The method as claimed in claim 1, wherein at least one of:
the photodetector array comprises a linear array of photodetectors or a 2D array of photodetectors; or
the photodetector array comprises an array of single-photon detectors such as an array of single-photon avalanche diodes (SPADs), an array of Silicon Photomultipliers (SiPM) or an array of Multi Pixel Photon Counters (MPPC), or an array of photomultiplier tubes (PMT); and the photodetector array comprises an array of photodiodes.

20. The method as claimed in claim 1, wherein at least one of:
the pulsed optical beam comprises near-IR light, short-wavelength IR light or mid-IR light, or
the pulsed optical beam comprises pulsed coherent light such as pulsed laser light.
